(19) United States
(12) Patent Application Publication
(10) Pub. No.: US 2021/0272438 A1
(43) Pub. Date: Sep. 2, 2021

(54) Finding of a Break in a Wire of a Robotic Working Tool System

(71) Applicant: HUSQVARNA AB, HUSKVARNA (SE)

(72) Inventor: Kent Askenmalm, Huskvarna (SE)

(21) Appl. No.: 17/254,395

(22) PCT Filed: Jul. 24, 2019
(86) PCT No.: PCT/EP2019/069887

§ 371 Date: Dec. 21, 2020

(30) Foreign Application Priority Data
Aug. 9, 2018 (SE) 1850962-0

(51) Int. Cl. G08B 21/18; A01D 34/00; G05D 1/02

(52) U.S. Cl. CPC G08B 21/185; A01D 2101/00; G05D 1/0265; A01D 34/008

(57) ABSTRACT

A robotic working tool system (200) comprising a base station (210) comprising a signal generator (240), a wire (230) and a robotic working tool (100) comprising at least one wire sensor (170), the robotic working tool system (200) being configured for: generating a detection signal (235) in the signal generator (240); transmitting the detection signal (235) through the wire (230); detecting a break in the wire by detecting that the detection signal is not detectable; and in response thereto emitting an alert.

### TECHNICAL FIELD

This application relates to robotic working tools and in particular to a system and a method for performing improved finding of a break in a boundary wire.

### BACKGROUND

Automated or robotic power tools such as robotic lawnmowers are becoming increasingly more popular. In a typical deployment, a work area, such as a garden, is enclosed by a boundary wire with the purpose of keeping the robotic lawnmower inside the work area. The robotic lawnmower is typically configured to sense a magnetic field emitted by a control signal being transmitted through the boundary wire.

Should the boundary wire suffer a break, the control signal may no longer be transmitted through the boundary wire and the system should not be used. As the boundary wire is most commonly (at least partially) buried in the ground of the work area, it may be difficult to locate the break.

To find a break there are some tools available for enabling a user to more easily find a break. They work so as that a current is applied to the boundary wire and then the user walks around the perimeter (where the boundary wire is laid) and checks for the applied current. When the user can no longer find the break, the break has already been passed and is between the current position and the last point checked.

However, this is tedious work and it requires basic knowledge of how to work with electrical equipment, something that many homeowners do not possess at a comfortable skill level. It also requires additional equipment that adds to the overall cost. Furthermore, having to buy the equipment may take a long time during which, the system cannot be used due to the break. Alternatively, an AM radio receiver may be used. This however, requires quite some knowledge on the part of the user and is not a widespread method and, in any case, it is just as time-consuming as using the dedicated break-finding tools, even if being a cheaper alternative.

Thus, there is a need for improved determining of a position for a break in a boundary wire.

### SUMMARY

As will be disclosed in detail in the detailed description, the inventors have realized that the immediate alert when a break in the boundary wire may enable a user to find the break more easily, as the user is made aware instantly of the break and may mark the position of the break, or at least close to the break.

It is therefore an object of the teachings of this application to overcome or at least reduce those problems by providing a robotic working tool system comprising a base station comprising a signal generator, a wire and a robotic working tool comprising at least one wire sensor, the robotic working tool system being configured for: generating a detection signal in the signal generator; transmitting the detection signal through the wire; detecting a break in the wire by detecting that the detection signal is not detectable; and in response thereto emitting an alert.

It is also an object of the teachings of this application to overcome the problems by providing a method for use in a robotic working tool system comprising a base station comprising a signal generator, a wire and a robotic working tool comprising at least one wire sensor, the method comprising: generating a detection signal in the signal generator; transmitting the detection signal through the wire; detecting a break in the wire by detecting that the detection signal is not detectable; and in response thereto emitting an alert.

According to a second aspect, it is an object of the teachings of this application to overcome or at least reduce those problems by providing a user device comprising a sensor for detecting a magnetic field emitted by a boundary wire through which a detection signal is being transmitted, the user device being configured for detecting a break in the boundary wire by detecting that the detection signal is not detectable; and in response thereto emitting an alert.

According to a second aspect, it is an object of the teachings of this application to overcome or at least reduce those problems by providing a method for use in a user device comprising a sensor for detecting a magnetic field emitted by a boundary wire through which a detection signal is being transmitted, the method comprising detecting a break in the boundary wire by detecting that the detection signal is not detectable; and in response thereto emitting an alert.

Other features and advantages of the disclosed embodiments will appear from the following detailed disclosure, from the attached dependent claims as well as from the drawings. Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention will be described in further detail under reference to the accompanying drawings in which:

FIG. 1A shows an example of a robotic working tool exemplified as a robotic lawnmower according to one embodiment of the teachings herein;

FIG. 1B shows a schematic view of the components of an example of a robotic working tool exemplified as a robotic lawnmower according to one embodiment of the teachings herein;

FIG. 2 shows an example of a robotic working tool system exemplified as a robotic lawnmower system according to the teachings herein;

FIGS. 3A, 3B and 3C each shows an instance of an example situation handled by a robotic working tool system according to the teachings herein; and

FIG. 4 shows a corresponding flowchart for a method according to an example embodiment.

### DETAILED DESCRIPTION

The disclosed embodiments will now be described more fully hereinafter with reference to the accompanying drawings, in which certain embodiments of the invention are shown. This invention may, however, be embodied in many different forms and should not be construed as limited to the embodiments set forth herein; Like numbers refer to like elements throughout.

It should be noted that even though the description given herein will be focused on robotic lawnmowers, the teachings herein may also be applied to, robotic ball collectors, robotic mine sweepers, robotic farming equipment, or other robotic working tools to be employed in a work area defined by a boundary wire.

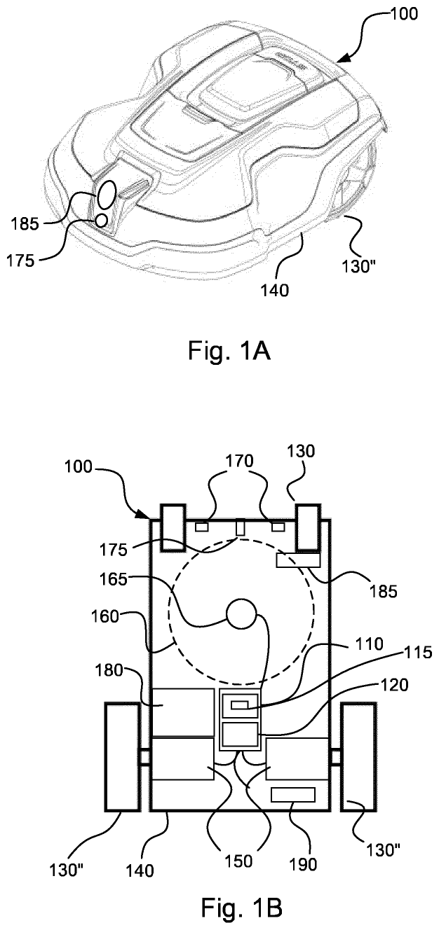

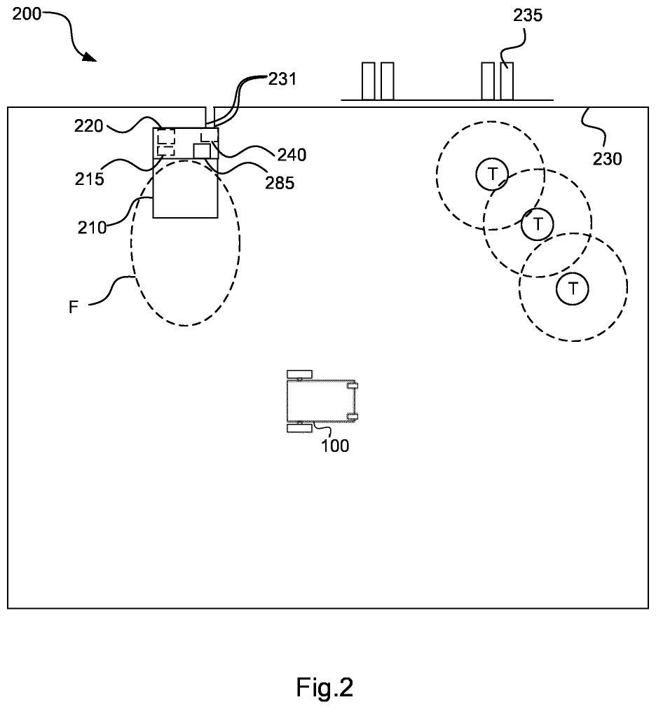

FIG. 1A shows a perspective view of a robotic working tool 100, here exemplified by a robotic lawnmower 100, having a body 140 and a plurality of wheels 130 (only one shown). The robotic lawnmower 100 may comprise charging skids for contacting contact plates (not shown in FIG. 1) when docking into a charging station (not shown in FIG. 1 but referenced 210 in FIG. 2) for receiving a charging current through, and possibly also for transferring information by means of electrical communication between the charging station and the robotic lawnmower 100.

FIG. 1B shows a schematic overview of the robotic working tool 100, also exemplified here by a robotic lawnmower 100, having a body 140 and a plurality of wheels 130. In the exemplary embodiment of FIG. 1B the robotic lawnmower 100 has 4 wheels 130, two front wheels 130′ and the rear wheels 130″. At least some of the wheels 130 are driveably connected to at least one electric motor 150. It should be noted that even if the description herein is focused on electric motors, combustion engines may alternatively be used possibly in combination with an electric motor. In the example of FIG. 1B, each of the rear wheels 130″ is connected to a respective electric motor 150. This allows for driving the rear wheels 130″ independently of one another which, for example, enables steep turning.

The robotic lawnmower 100 also comprises a controller 110. The controller 110 may be implemented using instructions that enable hardware functionality, for example, by using executable computer program instructions in a general-purpose or special-purpose processor that may be stored on a computer readable storage medium (disk, memory etc) 120 to be executed by such a processor. The controller 110 is configured to read instructions from the memory 120 and execute these instructions to control the operation of the robotic lawnmower 100 including, but not being limited to, the propulsion of the robotic lawnmower. The controller 110 may be implemented using any suitable, available processor or Programmable Logic Circuit (PLC). The memory 120 may be implemented using any commonly known technology for computer-readable memories such as ROM, RAM, SRAM, DRAM, FLASH, DDR, SDRAM or some other memory technology.

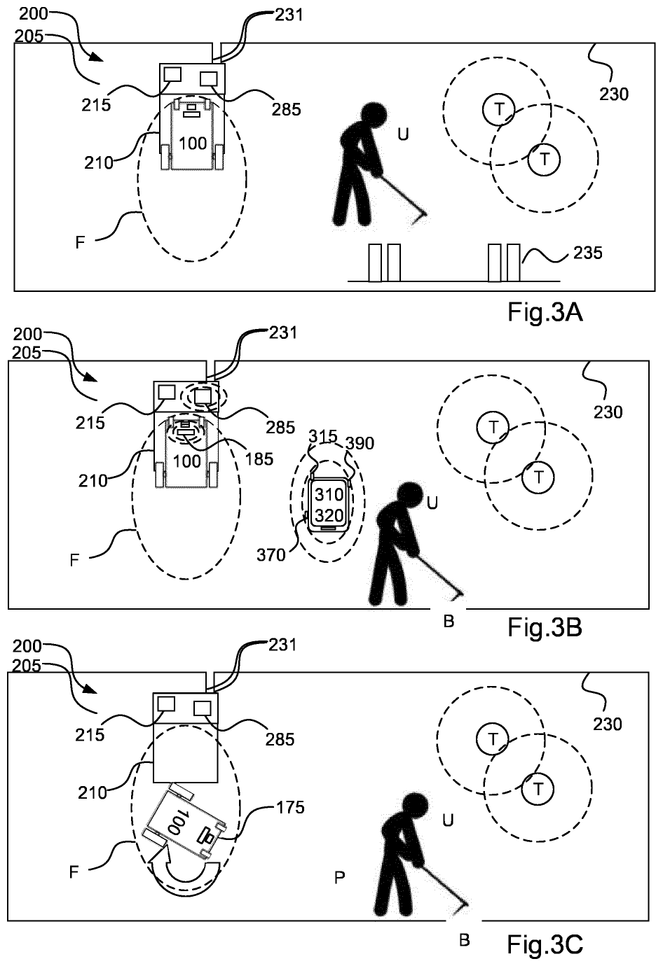

The robotic lawnmower 100 may further be arranged with a wireless communication interface 115 for communicating with other devices, such as a server, a personal computer or smartphone (or a tablet computer), or the charging station. Examples of wireless communication standards are Bluetooth, Global System Mobile (GSM) and LTE (Long Term Evolution), to name a few. In one embodiment, the robotic lawnmower 100 is configured to communicate with a charging station (referenced 210 in FIG. 2) for receiving and/or transmitting information on an operating status of the boundary wire. In one embodiment, the robotic lawnmower 100 is configured to communicate with a communication device of a user (referenced 310 in FIG. 3B), possibly a device commonly called a UE (User Equipment) in the field of telecommunication, for example for transmitting information on an operating status of the boundary wire.

The robotic lawnmower 100 also comprises a grass cutting device 160, such as a rotating blade 160 driven by a cutter motor 165. The grass cutting device being an example of a work tool 160 for a robotic working tool 100. The robotic lawnmower 100 also has (at least) one battery 180 for providing power to the motors 150 and the cutter motor 165.

The robotic lawnmower 100 may be further configured to have at least one magnetic sensor 170 arranged to detect a magnetic field (not shown) emitted by a control signal (not shown in FIG. 1, but referenced 235 in FIG. 2) and thereby detecting a boundary wire (not shown in FIG. 1, but referenced 230 in FIG. 2) and/or for receiving (and possibly also sending) information from a signal generator (will be discussed with reference to FIG. 2). The sensor(s) 170 may thus also be referred to as boundary wire detector(s). In some embodiments, the sensor(s) 170 are connected to the controller 110, and the controller 110 may be configured to process and evaluate any signals received from the sensor(s) 170. As mentioned above, the sensor signals may be caused by the magnetic field being generated by the control signal being transmitted through the boundary wire. This enables the controller 110 to determine whether the robotic lawnmower 100 is close to or crossing a boundary wire, or inside or outside an area enclosed by the boundary wire.

The sensor signals may also or additionally be caused by other signals generated by the signal generator, as will be discussed in greater detail with reference to FIG. 2, this enables the robotic lawnmower to navigate also according to other signal sources.

In one embodiment, the robotic lawnmower 100 further comprises at least one optical sensor 175, such as a camera, configured to receive optical information regarding the surroundings of the robotic lawnmower 100 to facilitate navigation of the robotic lawnmower based on an interpretation of the optical information. For a camera, the interpretation may be performed through image or video analysis. Other examples of optical sensors are Infra-Red (IR) sensors (passive or active), ambient light sensors, laser sensors to name a few examples.

In one embodiment, the robotic lawnmower 100 may further comprise at least one alert means 185. In one embodiment, the alert means comprises a light emitter such as a lamp or light (such as an LED light) configured to light or blink in a controlled manner thereby enabling providing information to a user for example regarding the operating state of the robotic lawnmower 100 or a robotic lawnmower system (referenced 200 in FIG. 2) comprising the robotic lawnmower 100. In one such embodiment, the alert means may be implemented as part of lamps used for other purposes as well, such as indicating the position of the robotic lawnmower or lighting up the surroundings for enabling the camera (in embodiments where such is incorporated in the robotic lawnmower 100) to operate properly. In one embodiment, the alert means comprises a sound device, such as a buzzer, configured to emit sounds in a controlled manner thereby enabling providing information to a user for example regarding the operating state of the robotic lawnmower 100 or a robotic lawnmower system (referenced 200 in FIG. 2) comprising the robotic lawnmower 100. The sounds emitted may be as simple as beeps or as complicated as synthesized or pre-recorded voice messages.

The robotic lawnmower 100 also comprises at least one satellite navigation sensor, such as a Global Positioning System (GPS) device 190, or a GLONASS device.

FIG. 2 shows a schematic view of a robotic working tool system 200 in one embodiment. The schematic view is not to scale. The robotic working tool system 200 comprises a charging station 210 and a robotic working tool 100. As with FIGS. 1A and 1B, the robotic working tool 100 is exemplified by a robotic lawnmower, but the teachings herein may also be applied to other robotic working tools adapted to operate within a work area. Even though the charging station will be disclosed as being a charging station for charging the robotic lawnmower 100, it should be noted that the charging station may be any type of base station and need not be arranged with charging means for the purpose of this application. The charging station may thus also be referred to as a base station. The use of a charging station has a benefit in that the garden maintenance may be performed while charging the robotic lawnmower.

The robotic working tool system 200 comprises a boundary wire 230 arranged to enclose a work area 205, in which the robotic lawnmower 100 is supposed to serve. For its operation within the work area 205, in the embodiment of FIG. 2, the robotic lawnmower 100 may also use the satellite navigation device 190, possibly supported by a deduced reckoning navigation sensor (not shown) to navigate the work area 205.

The work area 205 is in this application exemplified as a garden but can also be other work areas as would be understood. The garden contains a number of obstacles, exemplified herein by a number (3 as an example) of trees T.

The charging station 210 comprises a charging unit (not shown explicitly but taken to be an integral part of the charging station and a signal generator 240. The charging unit and the signal generator may also or alternatively, possibly each on their own, be parts of other units.

The signal generator 240 is connected (directly or indirectly) to the boundary wire 230 through connectors 231 for feeding a control signal 235 through the boundary wire 230. As the control signal 235 is transmitted through the boundary wire it will generate a magnetic field that may be sensed or detected by the sensor 170 of the robotic lawnmower 100. The sensed or detected signal will give rise to a corresponding signal in the robotic lawnmower 100 that may be used to identify the control signal and thereby detecting the border wire.

The signal generator 240 may also be configured to transmit other signals (not shown explicitly). Examples of such other signals are one or more guide signals being transmitted through a guide wire each, an F-field signal for generating an F-field (referenced F in FIG. 2) for enabling the robotic lawnmower 100 to more quickly navigate towards the charging station 210 and an N-field for enabling the robotic lawnmower 100 to navigate in relation to the charging station 210. In order to keep the figures clear and illustrative, only the F-field F is indicated and is taken to represent such other fields that are detected or sensed by the robotic lawnmower 100 and caused by signals generated by the signal generator 240.

The charging station 210 may also comprise a controller 220 comprising a computer-readable memory for storing at least operating instructions of the charging station. The controller 220 is configured to control the overall operation of the charging station. In one embodiment, the controller 220 is a controller of the signal generator 240. As for the controller 110 of the robotic lawnmower 100, the controller 220 of the charging station 210 may be implemented as one or several processors or other programmable logic units.

In one embodiment, the charging station 210 may also comprise alert means 285, such as those disclosed in relation to the robotic lawnmower 100. It should be noted that the alert means 185 of the robotic lawnmower 100 may not necessarily be the same as the alert means 285 of the charging station 210.

In one embodiment, the charging station 210 may also comprise a communication interface 215 enabling the charging station to establish communication with the robotic lawnmower 100, a server, a personal computer or smartphone (or a tablet computer), or the robotic lawnmower 100. Examples of wireless communication standards are Bluetooth, Global System Mobile (GSM) and LTE (Long Term Evolution), to name a few.

In one embodiment, the robotic lawnmower 100 is configured to communicate with the robotic lawnmower 100 for receiving and/or transmitting information on an operating status of the boundary wire. The charging station 210 may thus provide information on the operating status of the boundary wire and instructing or causing the robotic lawnmower 100 to emit an alert through the alert means 185 of the robotic lawnmower 100.

In one embodiment, the robotic lawnmower 100 is configured to communicate with a communication device of a user (referenced 310 in FIG. 3B), possibly a device commonly called a UE (User Equipment) in the field of telecommunication, for example for transmitting information on an operating status of the boundary wire. The charging station 210 may thus provide information on the operating status of the boundary wire and instructing or causing the UE 310 to emit an alert through the alert means of the UE 310.

In one embodiment, the communication interface 115 is effected through the charging plates (not shown) of the charging station whereby the charging current provided to the robotic lawnmower may be modulated to transmit information that is received by the robotic lawnmower 100.

In one embodiment, the communication interface 115 is effected through the control signal whereby the control signal may be modulated or otherwise modified to transmit information that is sensed and received by the robotic lawnmower 100.

In one embodiment, the charging station 210 may further comprise at least one alert means 285. In one embodiment, the alert means comprises a lamp or light (such as an LED light) configured to light or blink in a controlled manner thereby enabling providing information to a user for example regarding the operating state of the robotic lawnmower 100 or the robotic lawnmower system comprising the robotic lawnmower 100 and the boundary wire 230. In one embodiment, the alert means 285 comprises a sound device, such as a buzzer, configured to emit sounds in a controlled manner thereby enabling providing information to a user for example regarding the operating state of the robotic lawnmower 100 or the robotic lawnmower system 200 comprising the robotic lawnmower 100 and the boundary wire 230. The sounds emitted may be as simple as beeps or as complicated as synthesized or pre-recorded voice messages.

FIGS. 3A, 3B and 3C each shows a schematic view of a robotic lawnmower 100 operating as part of a robotic lawnmower system 200, such as exemplified the robotic lawnmower system 200 in FIG. 2.

The robotic lawnmower system 200 is drawn differently to that of FIG. 2, which indicates that the figures are not to scale and that many configurations of a robotic lawnmower system are possible, as would be understood by a skilled person, and are part of the teachings herein.

As can be seen in FIG. 3A, a user U is currently shown as working in the working area, such as performing garden maintenance work. Even though the description herein will focus on a user U working, it should be noted that the teachings also apply to other situations during which harm to the boundary wire may be caused, such as children or pets playing, or when objects are being moved.

In the example of FIG. 3A, the robotic lawnmower 100 is currently in the charging station 210 but it should be noted that the teachings may also be applied when the robotic lawnmower 100 is not in the charging station, such as when operating within the work area 205. As a working area 205 may be quite large and/or all areas of the work area may not be easily surveyable to a user U, even if the robotic lawnmower is operating in the work area, it may not be visible to the user U.

As the user U is working in the work area 205, here exemplified by a garden, the user U may inadvertently or accidentally damage or otherwise cause a break in the boundary wire 230. As has been discussed in the background section, any break to the boundary wire may be difficult to find especially as the boundary wire is most commonly buried in the ground of the work area and therefore not visible. Searching for the break may be a tedious and time-consuming undertaking that may be further complicated by objects, such as the trees T, in the garden blocking easy access to all parts of the boundary wire 230.

The inventors have realized that the main problem is that the user U simply does not know when and therefore also not where the break to the boundary wire 230 happened. The inventors are therefore proposing an ingeniously simple manner of alerting the user (or other users nearby) to the fact that the boundary wire 230 has suffered a break, by emitting an alert as soon as it is detected that a break has been caused.

Especially for embodiments where the control signal 235 is not transmitted when the robotic lawnmower 100 is docked in the charging station, but also for other embodiments, the robotic lawnmower system 200 may be put in a garden maintenance mode for example when garden work is to be performed. During such a garden maintenance mode, the control signal 235 is generated and transmitted through the boundary wire 230 irrespective of the operation of the robotic lawnmower 100.

As can be seen in FIG. 3B, the user U has caused a break B in the boundary wire 230, inadvertently or accidentally, resulting in that the control signal 235 can no longer be transmitted through the boundary wire 230.

That a control signal 235 is no longer being transmitted by the boundary wire may be detected in at least two ways, which may be used independently or in combination.

The charging station 210 is, in one embodiment, configured to detect that the control signal 235 is not again received at the connectors 231 as it is fed through these, i.e. that the circuit between the connectors 231 has been broken.

The robotic lawnmower 100 is, in one embodiment, configured to detect that the control signal 235 is no longer being sensed or detected, by detecting that the magnetic field caused by the control signal 235 is no longer detectable.

The robotic lawnmower system 200 may be configured to detect that the control signal is no longer being transmitted by enabling the charging station to detect this, and/or by enabling the robotic lawnmower 100 to detect this. The two manners may thus be used independently or in combination.

As it is detected that a break B has occurred, the robotic lawnmower system is configured to emit an alert to this effect. In one embodiment, the alert is emitted through the alert means 285 of the charging station 210. In one embodiment, the alert is emitted through the alert means 185 of the robotic lawnmower 100. In one embodiment, the alert may also or alternatively be emitted through the alert means 185 of the robotic lawnmower 100 and the alert means 285 of the charging station 210.

In FIG. 3B the alert is indicated by the dashed ovals being emitted from the respective alert means 185/285.

In one embodiment, the alert may not necessarily be emitted by the device detecting the break. Through the respective communication interfaces 115/215, the charging station 210 and the robotic lawnmower 100 may provide information to one another regarding the operating status of the boundary wire (i.e. working/not working) thereby being able to cause or instruct the other device to emit an alert. A break B detected by the charging statin may therefore cause an alert to be emitted by the alert means 185 of the robotic lawnmower 100, possibly in addition to any alerts being emitted by the alert means 285 of the charging station 210. Likewise, a break B detected by the robotic lawnmower 100 may therefore cause an alert to be emitted by the alert means 285 of the charging station 210, possibly in addition to any alerts being emitted by the alert means 185 of the robotic lawnmower 100.

As shown in FIG. 3B, the user U may be carrying or have close at hand a user device 310, such as for example a smart phone or other User Equipment. The user device 310 may alternatively be a dedicated device.

Generally, the user device 310 comprises a communication interface indicated by the antenna 315 and alert means indicated by the display 320. The alert means 320 need not be a display, but may alternatively or additionally be a vibrator, a sound emitter and/or a light emitter. In one embodiment the communication interface 315 is for communicating with other devices, such as a server, a personal computer or smartphone (or a tablet computer), the robotic lawnmower 100 or the charging station 210. Examples of wireless communication standards are Bluetooth®, Global System Mobile (GSM) and LTE (Long Term Evolution), to name a few. In one embodiment, the communication may be direct, device to device. In one embodiment, the communication may be effected through a robotic lawnmower operating application, whereby the communication is effected as per the application, which may be direct and/or indirect.

In one embodiment, the user device 310 is configured to communicate with the charging station 210 for receiving information on an operating status of the boundary wire. In one embodiment, the user device 310 is configured to communicate with the robotic lawnmower 100 for receiving information on an operating status of the boundary wire. As the user device 310 receives information on the operating status of the boundary wire, it may be caused or instructed to emit an alert.

In one embodiment the alert is emitted through a user device 310 of another user, notifying the user that a break has happened even if the user is not in the vicinity of the work area as the break happens.

As a user U or another user notices the alert, the user U or another user is made aware of the at least approximate position of the break B and so knows where to start looking.

In cases where the alert may not be immediately noticed, the robotic lawnmower system 200 may also be configured to determine the location or position of the user U as the break B is detected. FIG. 3C shows an instance where a location or position P of the user U is determined.

The user device 310 may additionally comprise a location determining device 390, such as a GPS device 390, commonly found in smartphones for example. In such an embodiment, the user device 310 may thus be configured to determine the location or position (referenced P in FIG. 3C) of the user U as the break B is detected and communicate the location to the charging station 210, the robotic lawnmower 100 an/or a server so that the user U or another user may later retrieve the position P and know at least approximately where to start looking.

The robotic lawnmower system 200 may thus be configured to determine the location of the user U as the break happens by receiving a position P of the user, the position determined as the break is detected.

Knowing where to look greatly reduces the time needed to find the break in the boundary wire 230.

In an embodiment where the robotic lawnmower 100 is configured with an optical sensor 175, such as a camera for example, the robotic lawnmower system 200 may be configured to determine the position P of the user by controlling the robotic lawnmower 100 to reverse out of or otherwise exit the charging station 210 and perform a scan of the work area 205 by rotating while using the optical sensor 175. The optic data stream provided by the optical sensor, i.e. the video or image stream in case of the optical sensor being a camera 175 may be analysed to detect various objects, possibly identifying the position P of the user U.

As the user U is detected in the optic data stream provided by the optical sensor, the position may be communicated to a user device or to a server for later retrieval through a robotic lawnmower controlling application.

Alternatively or additionally, the robotic lawnmower 100 may be configured to stop rotating as the user U is detected, thereby indicating an approximate position by simply following the line of sight from the optical sensor to the boundary wire 230, the robotic lawnmower 100 effectively pointing to a position at least close to where the break B happened.

The optic data stream provided by the optical sensor, i.e. the video or image stream in case of the optical sensor being a camera 175 may also or alternatively be stored so that it may be viewed by the user U (or another user) for identifying an approximate position of the user U or other persons or animals that may have caused the break at the approximate time of the break (the time difference for example depending on the rotation speed of the robotic lawnmower 100). The robotic lawnmower may thus perform a full rotation or a partial rotation stopping when a user (or other object—of interest) has been identified.

Even though the control signal 235 in the boundary wire 230 may no longer be detectable, the rotation may nevertheless be effected safely possibly based on detecting another signal, such as the F-field. As the robotic lawnmower 100 is only exiting the charging station by a distance that enables it to rotate, the robotic lawnmower 100 is not as such entering the work area but may be seen as still being in the docking station, i.e. in a docked state.

As mentioned above, the functionality of detecting a break and alerting a user may be dependent on the robotic lawnmower system 200 being put in a garden maintenance mode. Such a mode may be entered through a user input panel on the robotic lawnmower 100, the charging station 210 or on the user device 310. Alternatively or additionally, the garden maintenance mode may be specified in a working schedule for the robotic lawnmower system 200.

In one embodiment the robotic lawnmower may be configured to follow a user when the robotic lawnmower is in the garden maintenance mode. This facilitates for the user to hear or be made aware of any alerts emitted by the robotic lawnmower 100.

This may also be used by the user to initiate a work session or at least cause the robotic lawnmower to perform some work in an area that the user may not be satisfied with. In one such embodiment, the robotic lawnmower 100 may be configured to restrict the geographical extension of such work, especially if operating in a (semi-) random pattern, where the movement between each turn may be restricted.

The robotic lawnmower may also be used to carry tools to be used during the garden maintenance.

The robotic lawnmower 100 is, in one embodiment, configured to move along the boundary wire in the garden maintenance mode. This enables the robotic lawnmower to follow a user moving along the boundary wire. The robotic lawnmower 100 may be configured to move at a certain speed, to move at regular intervals, and or to move as a move command is issued possibly through the control panel.

The robotic lawnmower 100 is, in one embodiment, configured to track a user as the user moves around the work area. The robotic lawnmower 100 may in one such embodiment be configured to track or follow the user by following a user device 300 of the user. The user device 300 may be a smart phone (as is discussed in this application). The user device 300 may alternatively be or comprise a tag capable of wireless communication that the robotic lawnmower can communicate with and thus follow. The communication may comprise transmitting a location. The tracking may also be based on following a signal strength of the communication signals emitted from the user device 300. A simple RFID circuit could thus be utilized to enable such tracking.

In an embodiment where the robotic lawnmower 100 is arranged with a camera or other optical sensor the robotic lawnmower 100 may be configured to track the user through visual tracking. In one embodiment the user to be tracked is the user in front of—or first identified or detected by—the robotic lawnmower as the robotic lawnmower is put in the garden maintenance mode.

In one embodiment the garden maintenance mode may be associated with a time limit so that after the time limit has passed the robotic lawnmower exits the garden maintenance mode. In one example the time limit may be 0.25, 0.5, 0.75, 1, 1.5, 2, 3, 4 or 5 hours.

The garden maintenance mode may also or alternatively be exited due to a user command, or for example the starting of a scheduled working session.

In one embodiment, the robotic lawnmower 100 may be configured to ensure that it is in the charging station when exiting the garden maintenance mode. In such an embodiment the robotic lawnmower may thus return to the charging station if it should not be in the charging station as the garden maintenance mode is exited or as it expires.

In one embodiment, the robotic lawnmower 100 may be configured to start a working session as the garden maintenance mode is exited.

It should be noted that, at least for embodiments where the robotic lawnmower 100 detects the break in the boundary wire and emits an alert, this is done for alerting the user and is, as such, directed at solving a garden maintenance issue, namely finding the break B in the boundary wire 230. The teachings herein thus also provide for a new use, namely to use at least the robotic lawnmower 100 to more easily find or locate the break B by alerting a user U to the fact that there has been a break in the boundary wire and by doing this as it is detected that the break has occurred, which is done more or less at the same time as the break occurs. Some contemporary robotic lawnmowers are arranged to display a message on a control panel whether a control signal is detected or not. However, such systems do not inform a user where the break is and are thus not arranged or used for such use.

In one embodiment, the signal generator 240 may be configured to transmit a detection signal, other than or overlapping the control signal 235 through the boundary wire when put in a garden maintenance mode. This could be used to ensure that the robotic lawnmower does not start operating during the garden maintenance mode, as the control signal may be missing, but still enable for detecting a break B in the boundary wire 230.

In the embodiments disclosed above, the control signal constitutes the detection signal.

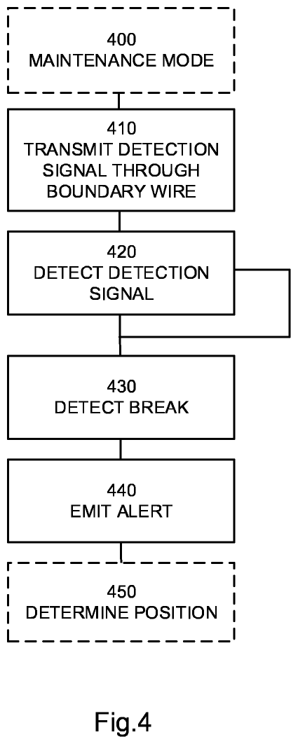

FIG. 4 shows a flowchart of a general method according to the teachings herein. A detection signal, such as a control signal, is transmitted 410 through the boundary wire 230. Optionally the robotic lawnmower system 200 is configured to be put 400 in a garden maintenance mode before transmitting the detection signal. The detection signal is detected 420 repeatedly or continuously until it is detected that the detection signal is no longer detectable, i.e. detecting 430 that a break has occurred. In one embodiment, it is determined whether the detection signal is actually being transmitted before determining that a break has occurred. As it is detected that a break has occurred, an alert is emitted 440. In some embodiments the position of a user is also determined 450.

As has been indicated in at least the detailed description, each step (possibly apart from the transmission of the detection signal which is done by the signal generator) may be performed by the robotic lawnmower 100, the charging station or a combination of the two. Likewise, the determination of the position and the emitting of the alert may be performed by or in combination with a user device 310.

It should be noted that even though the teachings herein have been focussed on detecting a break in the boundary wire, it may also be utilized to detect a break in another wire, such as a guide wire for example. Other examples are the wire for generating the F-field, or the wire for generating the N-filed. As the robotic lawnmower may be operable even when such fields are not sensed, this is beneficial as the break may otherwise be difficult to notice even during several work sessions.

In one embodiment, the user device 310 may be arranged with a sensor 370 for detecting the boundary wire 230, or at least the detection signal 235 being transmitted through the boundary wire 230. Such a sensor 370 may be of a type similar to the sensor(s) 170 discussed in relation to the robotic lawnmower 100. In such an embodiment, the user device 310 may also be configured to detect that the detection signal is no longer detectable, and thereby detect that a break has (possibly) occurred or at least that the detection signal is no longer being transmitted. As it is detected that the detection signal is no longer detected, the user device 310 is configured to emit an alert to this effect, informing the user that a break B has occurred. In one such embodiment, the user device 310 may also be configured to detect that the sensor(s) is close to the boundary wire, where “close to” is determined by comparing that a received signal strength exceeds a threshold value, or by determining a distance corresponding to the signal strength and indicating the distance to the user U, possibly by alerting (such as blinking and/or beeping) at increasing frequency and/or amplitude as the distance decreases/amplitude increases. This enables a user to be made aware that the user is working close to a boundary wire so the user can take precautionary measures to ensure that the boundary wire is not broken, or at least be more careful.

In an embodiment where the user device is a telecommunications equipment, such as a smartphone or a tablet computer, the user device 310 may be configured to utilize a radio application of the user device 310 to sense the signals, effectively making the antenna 315 the sensor 370.

Even though the user device 310 has been disclosed as being a standalone part, the user device 310 may be comprised in the robotic lawnmower system 200.

1. A robotic working tool system comprising a base station comprising a signal generator, a wire and a robotic working tool comprising at least one wire sensor, the robotic working tool system being configured to:
generate a detection signal in the signal generator;
transmit the detection signal through the wire;
detect a break in the wire by detecting that the detection signal is not detectable; and in response thereto emit an alert alerting a user to detect the fact that the wire has suffered a break.

2. The robotic working tool system according to claim 1, wherein the robotic working tool is configured to detect the break in the wire by detecting that the detection signal is not detectable; and in response thereto emitting the alert.

3. The robotic working tool system according to claim 2, wherein the robotic working tool is further configured to emit the alert at least through the base station.

4. The robotic working tool system according to claim 1, wherein the base station is configured to detecting the break in the wire by detecting that the detection signal is not detectable; and in response thereto emitting an alert.

5. The robotic working tool system according to claim 4, wherein the base station is further configured to emit the alert at least through the robotic working tool.

6. The robotic working tool system according to claim 4, wherein the base station further comprises alert means and wherein the base station is further configured to emit the alert at least through the alert means.

7. The robotic working tool system according to claim 1, wherein the robotic working tool system further comprises a communication interface and wherein the robotic working tool system is further configured to: establish a connection with a user device and to emit the alert at least through the user device.

8. The robotic working tool system according to claim 1, wherein the robotic working tool system is further configured to determine an approximate location of the break by determining a position of a user of the robotic work tool system.

9. The robotic working tool system according to claim 8, wherein the robotic working tool comprises an optical sensor, and wherein the robotic working tool system is further configured to determine the position of the user by generating a stream of optical data during an at least partial rotation of the robotic working tool.

10. The robotic working tool system according to claim 8, wherein the robotic working tool system is further configured to determine the position of a user by receiving a position from the user device.

11. The robotic working tool system according to claim 1, wherein the robotic working tool system is further configured to be set in a garden maintenance mode before detecting the break.

12. The robotic working tool system according to claim 7, further comprising the user device.

13. The robotic working tool system according to claim 1, wherein the wire is a boundary wire.

14. The robotic working tool system according to claim 1, wherein the robotic working tool is a robotic lawnmower and the robotic working tool system is a robotic lawnmower system.

15. The robotic working tool system according to claim 1, wherein the user device is a telecommunications device.

16. A method for use in a robotic working tool system comprising a base station comprising a signal generator, a wire and a robotic working tool comprising at least one wire sensor, the method comprising:
generating a detection signal in the signal generator;
transmitting the detection signal through the wire;
detecting a break in the wire by detecting that the detection signal is not detectable; and in response thereto emitting an alert alerting a user to detect the fact that the wire has suffered a break.

17. A user device configured to perform the method of claim 18, the user device comprising a sensor for detecting the magnetic field emitted by the boundary wire.

18. A method for detecting a magnetic field emitted by a boundary wire through which a detection signal is being transmitted, the method comprising detecting a break in the boundary wire by detecting that the detection signal is not detectable; and in response thereto emitting an alert alerting a user to detect the fact that the boundary wire has suffered a break.
